(19) United States
(12) Patent Application Publication
(10) Pub. No.: US 2006/0228591 A1
(43) Pub. Date: Oct. 12, 2006

(54) MAGNETIC RECORDING MEDIUM

(76) Inventors: Masaru Terakawa, Miyagi (JP); Katsunori Maeshima, Miyagi (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/278,708

(22) Filed: Apr. 5, 2006

(30) Foreign Application Priority Data
Apr. 6, 2005 (JP) P2005-109614

(51) Int. Cl. G11B 5/706

(52) U.S. Cl. 428/844.3

(57) ABSTRACT

A magnetic recording medium includes a nonmagnetic substrate, a nonmagnetic underlayer containing at least inorganic particles and a binder resin, and a magnetic layer containing at least a magnetic powder, a binder resin, and abrasive particles, the nonmagnetic underlayer and the magnetic layer being disposed in that order on at least one principal surface of the nonmagnetic substrate. The magnetic layer is formed after a coating material for forming the nonmagnetic underlayer is applied and subjected to drying treatment. The thickness Z of the magnetic layer is 100 nm or less, the average particle diameter Da (nm) of the abrasive particles and the thickness Z (nm) of the magnetic layer satisfy the relationship 1.0≦Da/Z≦1.5, and the maximum particle diameter Dm (nm) and the thickness Z (nm) of the magnetic layer satisfy the relationship Dm/Z≦1.8.

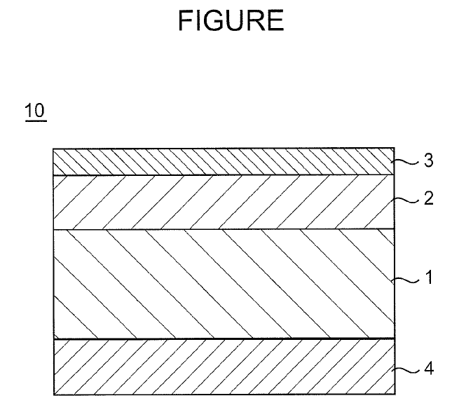

### CROSS REFERENCES TO RELATED APPLICATIONS

The present invention contains subject matter related to Japanese Patent Application JP 2005-109614 filed in the Japanese Patent Office on Apr. 6, 2005, the entire contents of which are incorporated herein by reference.

### BACKGROUND OF THE INVENTION

1. Field of the Invention

The present invention relates to a high-density magnetic recording medium including an extremely thin magnetic layer (recording layer). More particularly, the invention relates to a technique which achieves both a good electromagnetic conversion characteristic and excellent running durability.

2. Description of the Related Art

In recent years, the volume of information has been increasing due to digital recording and the like, and further increases in density and shorter wavelength recording are anticipated in the field of magnetic recording mediums.

Accordingly, with respect to magnetic recording mediums, in particular, used for systems provided with high-sensitivity magnetic reproducing heads (MR heads and GMR heads), magnetic properties have been improved in order to improve short-wavelength output and electromagnetic conversion characteristic (C/N characteristic), and the thicknesses of magnetic layers have been decreased and the surfaces of magnetic layers have been smoothened in order to reduce spacing loss and modulation noise.

As the magnetic recording medium having such a thin magnetic layer (recording layer), a structure in which a nonmagnetic underlayer and a magnetic layer are disposed on a substrate has been developed and commercialized.

As a typical method for forming such a dual-layer thin-film magnetic recording medium, a wet-on-wet process may be mentioned in which a nonmagnetic underlayer is formed by application of a nonmagnetic coating material, and simultaneously or consecutively a magnetic dispersion liquid is applied thereon while the nonmagnetic underlayer is in a wet state. (For example, refer to Japanese Unexamined Patent Application Publication No. 63-191315.)

Although excellent in terms of productivity and cost, this film forming method has the following problems: Dual-layer coating cannot be performed satisfactorily unless the viscoelasticity of the nonmagnetic underlayer is close to that of the coating liquid of the upper magnetic layer. If not, coating defects and degradation in the surface state are caused, and it is not possible to produce a magnetic recording medium having excellent surface properties.

Various studies have been conducted to overcome such problems. However, there remains a problem in that, in the wet-on-wet coating process of applying an upper layer onto a nonmagnetic underlayer which is in a wet state, coating defects due to the interface fluctuation between the nonmagnetic underlayer and the magnetic layer inevitably occur. The coating defects may result in noise generation and degradation in electromagnetic conversion characteristic. There is a need for solving this problem so that the thickness of recording layers can be further decreased.

On the other hand, as another dual-layer coating process, a wet-on-dry process has been proposed in which after application of a nonmagnetic underlayer, drying treatment is performed, and then a magnetic layer, i.e., a recording layer, is disposed thereon. (For example, refer to Japanese Unexamined Patent Application Publication Nos. 2000-207732 and 2001-84553.)

In this process, unlike the wet-on-wet process described above, since a magnetic coating material is applied after the nonmagnetic underlayer is dried, coating defects due to interface fluctuation between the nonmagnetic underlayer and the magnetic layer do not easily occur, and fluctuation in the thickness of the magnetic layer can be suppressed. Consequently, in particular, in an extra-high-density magnetic recording medium including an extremely thin magnetic layer, an excellent electromagnetic conversion characteristic can be achieved, which is advantageous.

However, when an upper magnetic layer is formed with an extremely small thickness by the wet-on-dry process, although the electromagnetic conversion characteristic in short-wavelength recording can be improved, running durability is degraded. The reason for this is as follows: When dual-layer forming is performed using the wet-on-wet process, since a magnetic layer is applied onto a nonmagnetic underlayer which is still in a wet state, a certain amount of abrasive particles incorporated in the magnetic layer becomes buried in the nonmagnetic layer. In contrast, when dual-layer forming is performed using the wet-on-dry process, the amount of abrasive particles exposed to the surface of the magnetic layer and the amount of abrasive particles substantially contained in the magnetic layer are larger than those in the case of film formation by the wet-on-wet process, thereby more greatly affecting the surface properties.

That is, even if the same amount of abrasive particles having the same properties is used in both processes, in the case of film formation by the wet-on-dry process, in particular, abrasive particles are more easily exposed. Thus, running durability is degraded, the head life is decreased due to uneven abrasion of the magnetic head, and the electromagnetic conversion characteristic is degraded due to an increase in noise.

With respect to abrasive particles, several studies have been conducted in order to improve running durability. (For example, refer to Japanese Unexamined Patent Application Publication Nos. 5-266464 and 8-55330.) These techniques studied are targeted for magnetic recording mediums in which film formation is performed by a wet-on-wet process and magnetic recording mediums having a single-layered magnetic layer structure, and therefore are unable to cope with higher density recording of magnetic recording mediums, which is expected to further progress in the future.

### SUMMARY OF THE INVENTION

The present inventors have conducted studies on the thickness of a magnetic layer and abrasive particles in a high-recording-density magnetic recording medium produced by a dual-layer forming technique using a wet-on-dry process for the purpose of achieving both excellent running durability and a good electromagnetic conversion characteristic.

According to an embodiment of the present invention, a magnetic recording medium includes a nonmagnetic substrate, a nonmagnetic underlayer containing at least inorganic particles and a binder resin, and a magnetic layer containing at least a magnetic powder, a binder resin, and abrasive particles, the nonmagnetic underlayer and the magnetic layer being disposed in that order on at least one principal surface of the nonmagnetic substrate, wherein the magnetic layer is formed after a coating material for forming the nonmagnetic underlayer is applied and subjected to drying treatment, the thickness Z of the magnetic layer is 100 nm or less, the average particle diameter Da (nm) of the abrasive particles and the thickness Z (nm) of the magnetic layer satisfy the relationship 1.0≦Da/Z≦1.5, and the maximum particle diameter Dm (nm) and the thickness Z (nm) of the magnetic layer satisfy the relationship Dm/Z≦1.8.

According to the embodiment of the present invention, in a high-density-recording-type magnetic recording medium including an extremely thin magnetic layer formed by a wet-on-dry process, it is possible to achieve both excellent running durability and a good electromagnetic conversion characteristic.

### BRIEF DESCRIPTION OF THE DRAWINGS

FIGURE is a schematic cross-sectional view of a magnetic recording medium according to an embodiment of the present invention.

### DESCRIPTION OF THE PREFERRED EMBODIMENTS

A magnetic recording medium according to an embodiment of the present invention will be described in details with reference to the drawing. However, it is to be understood that present invention is not limited to the examples described below.

As shown in FIGURE, which is a schematic cross-sectional view showing an example, a magnetic recording medium 10 includes a nonmagnetic underlayer 2 and a magnetic layer 3 disposed in that order on one principal surface of a nonmagnetic substrate 1, and a backcoat layer 4 is disposed on the other principal surface.

The individual layers will be described below.

The nonmagnetic substrate 1 can be formed using any of known materials that are used as substrates for magnetic recording mediums.

Specific examples of the materials include polyesters, such as polyethylene terephthalate and polyethylene naphthalate; polyolefins, such as polyethylene and polypropylene; cellulose derivatives, such as cellulose triacetate, cellulose diacetate, and cellulose acetate butyrate; vinyl resins, such as polyvinyl chloride and polyvinylidene chloride; plastics, such as polycarbonates, polyimides, polyamides, and polyamide-imides; paper; metals, such as aluminum and copper; light alloys, such as aluminum alloys and titanium alloys; ceramics; and single crystal silicon.

These may be used alone or in combination of two or more.

The shape of the nonmagnetic substrate is appropriately selected depending on the desired magnetic recording medium and may be a film, a tape, a sheet, a disk, a card, a drum, or the like.

The nonmagnetic underlayer 2 will be described below.

The nonmagnetic underlayer 2 is formed by application of a coating material prepared by mixing inorganic particles, a binder resin, and other additives using an organic solvent.

As the inorganic particles constituting the nonmagnetic underlayer 2, any inorganic fine powder used for nonmagnetic layers disposed under magnetic layers in known magnetic recording mediums can be used.

Specific examples thereof include alumina, iron oxide, silicon carbide, chromium oxide, cerium oxide, geothite, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, and molybdenum disulfide. These may be used alone or in combination of two or more.

The shape of the inorganic particles may be any of acicular, spherical, plate-like, and cuboidal.

Furthermore, when the resulting magnetic recording medium is used for a high-sensitivity magnetic head (MR head or GMR head), in order to inhibit electrostatic discharge, addition of a conductive agent is preferable. Any known conductive agent can be used, and examples thereof include carbon black and conductive titanium oxide.

As the binder resin constituting the nonmagnetic underlayer 2, any known binder resin can be used. Examples thereof include vinyl chloride-vinyl acetate copolymers, vinyl chloride-vinyl acetate-vinyl alcohol copolymers, vinyl chloride-vinyl acetate-maleic acid copolymers, vinyl chloride-vinylidene chloride copolymers, vinyl chloride-acrylonitrile copolymers, acrylate-acrylonitrile copolymers, acrylate-vinylidene chloride copolymers, methacrylic acid-vinylidene chloride copolymers, methacrylate-styrene copolymers, thermoplastic polyurethane resins, phenoxy resins, polyvinyl fluoride, vinylidene chloride-acrylonitrile copolymers, butadiene-acrylonitrile copolymers, acrylonitrile-butadiene-methacrylic acid copolymers, polyvinyl butyral, cellulose derivatives, styrene-butadiene copolymers, polyester resins, phenolic resins, epoxy resins, thermosetting polyurethane resins, urea resins, melamine resins, alkyd resins, urea-formaldehyde resins, and mixtures of any of these.

Particularly preferred are polyurethane resins, polyester resins, acrylonitrile-butadiene copolymers, and the like, which have a flexibility imparting effect; and cellulose derivatives, phenolic resins, epoxy resins, and the like, which have a rigidity imparting effect. These resins may be used together with an isocyanate compound as a crosslinking agent to further improve durability.

As the organic solvent for preparing the coating material, any known solvent can be used. Examples thereof include ketone solvents, such as acetone, methyl ethyl ketone, methyl isobutyl ketone, and cyclohexanone; ester solvents, such as methyl acetate, ethyl acetate, butyl acetate, ethyl lactate, and glycol acetate monoethyl ester; glycol ether solvents, such as glycol monoethyl ether and dioxane; aromatic hydrocarbon solvents, such as benzene, toluene, and xylene; and organochlorine solvents, such as methylene chloride, ethylene chloride, carbon tetrachloride, chloroform, ethylene chlorohydrin, and dichlorobenzene.

The nonmagnetic underlayer 2 is subjected to drying treatment prior to the formation of the magnetic layer 3 which will be described below.

The magnetic layer 3 will now be described below.

The magnetic layer 3 is formed by application of a coating material prepared by mixing at least a magnetic powder, a binder resin, and abrasive particles using an organic solvent.

As the magnetic powder, any ferromagnetic particles which have been used for coating-type magnetic recording mediums can be used.

Examples thereof include ferromagnetic iron oxide particles, ferromagnetic chromium dioxide, ferromagnetic barium ferrite, ferromagnetic alloy powders, ferromagnetic iron-platinum, and ferromagnetic iron nitride.

As the binder for forming the magnetic layer 3, any binder usable for coating-type magnetic recording mediums can be used. Specifically, any of the binder resins for forming the nonmagnetic underlayer exemplified above can be used.

As the organic solvent for preparing the magnetic coating material, any solvent which has been used for preparing coating materials can be used. Specifically, any of the organic solvents for forming the nonmagnetic underlayer exemplified above can be used.

As the abrasive particles, a known material can be used. Examples thereof include silica, alumina, titanium oxide, and ZnO₂.

The average particle diameter Da (nm) of the abrasive particles and the thickness Z (nm) of the magnetic layer satisfy the relationship 1.0≦Da/Z≦1.5, and the maximum particle diameter Dm (nm) of the abrasive particles and the thickness Z (nm) of the magnetic layer satisfy the relationship Dm/Z≦1.8.

It has been confirmed that by specifying the relationship between the abrasive particles and the thickness of the magnetic layer as described above, in particular, with respect to a high-density-recording type magnetic recording medium having a dual-layer structure including an underlayer and a recording layer formed by the wet-on-dry process, excellent running durability can be achieved, noise can be reduced, abrasion of the magnetic head can be suppressed, and a good electromagnetic conversion characteristic can be obtained.

Preferably, the abrasive particles are composed of 60 -alumina having a pH of 7.0 or less.

It has been confirmed that by using such α-alumina, it is possible to effectively prevent degradation in the surface properties due to aggregation of α-alumina and uneven abrasion of a magnetic head to which the magnetic recording medium is applied.

The thickness of the magnetic layer 3 is 100 nm or less.

It is desired to produce a high-density-recording-type magnetic recording medium. If the thickness of the magnetic layer 3 exceeds 100 nm, PW50 (pulse width at 50% of the peak value in an isolated reproducing waveform) increases, thus degrading high-density recording characteristics.

Furthermore, when signal reproduction is performed using a high-sensitivity reproducing magnetic head (MR head or GMR head), if the thickness of the magnetic layer exceeds 100 nm, the saturation magnetization Br of the magnetic layer becomes 0.25 T or more and saturation may occur depending on the various conditions in the reproducing head (saturation magnetic flux density and thickness of MR element, saturation magnetic flux density and thickness of soft-adjacent-layer (SAL), etc.), thus degrading the electromagnetic conversion characteristic (C/N).

The backcoat layer 4 can be formed using a binder resin, inorganic particles, a lubricant, and various additives, such as an antistatic agent.

By using a nonmagnetic underlayer 2 and a magnetic layer 3 disposed thereon instead of the backcoat layer 4, it is also possible to produce a large-capacity magnetic recording medium which has recording layers on both principal surfaces.

A method for fabricating a magnetic recording medium 10 according to an embodiment of the present invention will now be described.

First, a predetermined nonmagnetic substrate 1 suitable for a desired magnetic recording medium is prepared.

Subsequently, a coating material for forming a nonmagnetic underlayer 2 and a coating material for forming a magnetic layer 3 are prepared. These coating materials are each prepared by kneading and dispersing the materials described above in a predetermined solvent.

Any known kneading and dispersing method can be used without particular limitations. Examples of the method include methods using a continuous twin-screw kneader (extruder), a cokneader, a pressure kneader, or the like.

The nonmagnetic underlayer 2 is formed by application of a nonmagnetic coating material by a known method, such as gravure coating, extrusion coating, air doctor coating, or reverse-roll coating, and then drying treatment is performed.

After the nonmagnetic underlayer 2 is subjected to drying treatment, a magnetic coating material is applied by a known coating method, such as gravure coating, extrusion coating, air doctor coating, or reverse-roll coating.

Subsequently, magnetic field orientation treatment is performed in an orientation device while the magnetic coating material is in an undried state that allows the magnetic particles to have freedom of movement. Then, drying treatment is performed in a drying device.

Furthermore, calendering treatment and surface hardening treatment are performed, and then, as necessary, a backcoat layer 4 is formed. The magnetic recording medium 10 according to the embodiment of the present invention is thereby obtained.

The magnetic powder, the binder resin, the inorganic particles, the dispersant, the abrasive, the antistatic agent, other additives, such as an anticorrosive agent, and the organic solvent for preparing the coating materials are not particularly limited, and any of known materials may be used.

### EXAMPLES

Magnetic tape samples were fabricated, and the properties thereof were measured and evaluated. It is to be understood that the present invention is not limited to the examples described below.

Examples 1 to 10 and Comparative Examples 1 to 9

Magnetic coating materials having compositions described below were prepared.

With respect to each magnetic coating material, using magnetic particles selected from the magnetic powders shown in Table 1 and abrasive particles selected from the abrasives shown in Table 2, a dispersion liquid for a magnetic layer was prepared.

TABLE 1

| | Long-axis | Short-axis | | Magnet- | |
|---|---|---|---|---|---|
| | length | length | Coercivity | ization | Shape, |
| | (nm) | (nm) | (kA/m) | (Am/kg) | composition |
| Magnetic | 5 | 5 | 210 | 55 | Spherical, |
| powder I | | | | | Pt—Co |
| Magnetic | 30 | 10 | 206 | 112 | Acicular, |
| powder II | | | | | Fe—Co |
| Magnetic | 40 | 15 | 213 | 127 | Acicular, |
| powder III | | | | | Fe—Co |

TABLE 2

| | | | Maximum | |
|---|---|---|---|---|
| | | Average particle | particle | |
| Abrasive | Material | diameter (nm) | diameter | pH |
| A | Amorphous silica | 30 | 35 | — |
| B | Amorphous silica | 50 | 60 | — |
| C | Amorphous silica | 100 | 110 | — |
| D | Amorphous silica | 150 | 170 | — |
| E | Amorphous silica | 100 | 150 | — |
| F | Titanium oxide | 25 | 30 | — |
| G | α-alumina | 100 | 150 | 6.5 |
| H | α-alumina | 100 | 150 | 7.5 |

[Composition of Magnetic Coating Material]

Magnetic powder (selected from Table 1): 100 parts by weight

First binder: 9 parts by weight

(vinyl chloride-based copolymer (average degree of polymerization 300))

Second binder: 9 parts by weight

(polyester-based polyurethane resin (volume-average molecular weight 41,200, Tg 40° C.))

Abrasive particles (selected from Table 2): 5 parts by weight

Lubricant: stearic acid: 1 part by weight
: butyl stearate: 2 parts by weight

Solvent: methyl ethyl ketone: 20 parts by weight
: toluene: 20 parts by weight
: cyclohexanone: 10 parts by weight

The materials described above were kneaded with a kneader, and the resulting mixture was diluted with methyl ethyl ketone, toluene, and cyclohexanone and dispersed by a sand mill to form a dispersion liquid. Subsequently, 4 parts by weight of a polyisocyanate hardener (“Coronate L” manufactured by Nippon Polyurethane Industry Co., Ltd.) was added to the dispersion liquid, followed by stirring. A coating material for forming the magnetic layer was thereby prepared.

A coating material for a nonmagnetic underlayer was prepared in each of the examples and comparative examples.

[Composition of Dispersion Liquid for Nonmagnetic Underlayer]

First inorganic particles: α-iron oxide (long-axis length 50 nm, BET value 87 m²/g): 100 parts by weight

Second inorganic particles: carbon black (particle diameter 20 nm, DBP oil absorption 120 ml/100 g): 24 parts by weight

First binder: vinyl chloride-based copolymer (average degree of polymerization 300): 9 parts by weight

Second binder: polyester-based polyurethane resin (volume-average molecular weight 41,200, Tg 40° C.): 9 parts by weight

Lubricant: butyl stearate: 2 parts by weight
: stearic acid: 1 part by weight

Organic solvent: methyl ethyl ketone: 20 parts by weight
toluene: 20 parts by weight

The materials described above were kneaded, and the resulting mixture was diluted with the organic solvents and dispersed by a sand mill to form a dispersion liquid for a nonmagnetic underlayer.

Subsequently, 3 parts by weight of a polyisocyanate hardener (“Coronate L” manufactured by Nippon Polyurethane Industry Co., Ltd.) relative to 100 parts by weight of the first inorganic particles was added to the dispersion liquid to prepare a coating material for the non-recording underlayer.

### Fabrication of Magnetic Tapes in Examples 1 to 10 and Comparative Examples 1 to 7

In each of the example and comparative example, as a nonmagnetic substrate, a polyethylene terephthalate film with a thickness of 5.0 μm was prepared, and the coating material for the nonmagnetic underlayer described above was applied thereto at a thickness of 1.0 μm, followed by drying treatment. Subsequently, the coating material for forming the magnetic layer described above was applied so as to achieve a predetermined thickness (refer to Table 3).

Subsequently, magnetic field orientation treatment was performed and then drying treatment was performed, followed by winding. Calendering treatment and hardening treatment were then performed.

Subsequently, a coating material for a backcoat layer was prepared by adding 10 parts by weight of a polyisocyanate hardener (“Coronate L” manufactured by Nippon Polyurethane Industry Co., Ltd.) to a dispersion liquid for a backcoat layer having the composition described below, and the resulting coating material for the backcoat layer was applied to a principal surface of the nonmagnetic substrate opposite to the principal surface on which the magnetic layer was formed to form a backcoat layer with a thickness of 0.6 μm.

[Composition of Dispersion Liquid for Backcoat Layer]

Inorganic powder: carbon black (particle diameter 40 nm, DBP oil absorption 112.0 ml/100 g): 100 parts by weight

Binder: polyester-based polyurethane resin (volume-average molecular weight 71,200): 13 parts by weight

Binder: phenoxy resin (average degree of polymerization 100): 43 parts by weight

Binder: nitrocellulose resin (average degree of polymerization 90): 10 parts by weight

Solvent: methyl ethyl ketone: 500 parts by weight
: toluene: 500 parts by weight

The wide magnetic tape thus obtained was slit into a tape with a width of 8 mm. Thereby, magnetic recording tape samples in Examples 1 to 10 and Comparative Examples 1 to 7 were obtained.

### Fabrication of Magnetic Tapes in Comparative Examples 8 and 9

In each comparative example, the coating material for the nonmagnetic underlayer described above was applied at a thickness of 1.0 μm, and while the applied coating material is still in a wet state, the magnetic coating material described above was applied at a predetermined thickness (refer to Table 3 below) by the wet-on-wet process.

Subsequently, magnetic field orientation treatment was performed and then drying treatment was performed, followed by winding. Calendering treatment and hardening treatment were then performed.

Subsequently, a coating material for a backcoat layer was prepared by adding 10 parts by weight of a polyisocyanate hardener (“Coronate L” manufactured by Nippon Polyurethane Industry Co., Ltd.) to the dispersion liquid for the backcoat layer having the composition described below, and the resulting coating material for the backcoat layer was applied to a principal surface of the nonmagnetic substrate opposite to the principal surface on which the magnetic layer was formed to form a backcoat layer with a thickness of 0.6 μm.

After that, the same fabrication steps were carried out as those in Examples 1 to 10. Thereby, magnetic recording tape samples were fabricated.

With respect to the magnetic recording tape samples in Examples 1 to 10 and Comparative Examples 1 to 9 thus fabricated, the thickness of the magnetic layer was precisely measured, and the ratio (Da/Z) of the average particle diameter Da (nm) of the abrasive particles to the thickness Z (nm) of the magnetic layer and the ratio (Dm/Z) of the maximum particle diameter Dm (nm) of the abrasive particles to the thickness Z (nm) of the magnetic layer were calculated.

Furthermore, the electromagnetic conversion characteristic and running durability were measured and evaluated.

The individual measurement methods will be described below.

[Measurement of Thickness of Magnetic Layer]

With respect to each magnetic tape sample, sampling was performed in the longitudinal direction to obtain 10 test pieces, and the test pieces thus obtained were each cut parallel to the longitudinal direction using a microtome.

Subsequently, the cut surface of the magnetic tape was observed with a transmission electron microscope (TEM) JEM-200CX manufactured by JEOL Corporation at a magnification of 60,000 times or more. The thicknesses of the magnetic layer at 20 points or more on the cut surface of each test piece were observed in this manner.

The average of the thicknesses of the magnetic layer at 20 points or more in each test piece was calculated and defined as the thickness of the magnetic layer of the magnetic tape sample. The thickness of the magnetic layer is shown in Table 3 below.

[Electromagnetic Conversion Characteristic]

Each magnetic tape sample was evaluated using a fixed tester equipped with a recording head (MIG, gap 0.15 μm) and a reproducing head (GMR, gap 0.15 μm). After a signal with a wavelength of 0.25 μm was recorded, reproduced output and noise were measured using a spectrum analyzer. The level of a frequency component at ±2 MHz from the reproduced signal was defined as a noise level, and a ratio of the reproduced signal output to the noise output was defined as a C/N characteristic (C/N characteristic before running). The C/N characteristic of the magnetic tape sample in Comparative Example 6 was considered as a reference value (0.0 dB). Values obtained from the individual sample magnetic tapes relative to the reference value are shown as the C/N characteristic in Table 3 below.

[Running Durability]

Each magnetic tape sample was loaded into an 8-mm data cartridge to produce a measurement sample. Each measurement sample was allowed to run using an 8-mm travel device, and a signal with a wavelength of 0.25 μm was recorded for 10 minutes under an environment of temperature of 25° C. and humidity of 50%.

Subsequently, playback and rewind operation of the portion in which recording was performed for 10 minutes as described above was repeated 200 times. Then, reproduced output and noise were measured using a spectrum analyzer. The level of a frequency component at ±2 MHz from the reproduced signal was defined as a noise level, and a ratio of the reproduced signal output to the noise output was defined as a C/N characteristic (C/N characteristic after running). The decrease from the C/N characteristic before running was defined as a C/N degradation.

A C/N degradation of 0 to −0.5 dB was evaluated to be good, a C/N degradation of −0.5 to −1.0 dB was evaluated to be average, and a C/N degradation of −1.0 dB or less was evaluated to be poor. The results are shown in Table 3 below.

TABLE 3

| | | | Thickness | | | | Evaluation results | |
|---|---|---|---|---|---|---|---|---|
| | Magnetic | | of magnetic | Coating | | | | Running |
| | powder | Abrasive | layer (nm) | process | Da/Z | Dm/Z | C/N | durability |
| Example 1 | II | A | 25 | W/D | 1.20 | 1.40 | 0.3 | Good |
| Example 2 | II | B | 35 | W/D | 1.43 | 1.71 | 0.3 | Good |
| Example 3 | II | B | 40 | W/D | 1.25 | 1.50 | 0.9 | Good |
| Example 4 | II | B | 50 | W/D | 1.0 | 1.2 | 0.8 | Good |
| Example 5 | II | C | 80 | W/D | 1.25 | 1.38 | 0.6 | Good |
| Example 6 | I | C | 80 | W/D | 1.25 | 1.38 | 0.5 | Good |
| Example 7 | III | C | 80 | W/D | 1.25 | 1.38 | 0.4 | Good |
| Example 8 | II | D | 100 | W/D | 1.50 | 1.70 | 0.2 | Good |
| Example 9 | II | F | 23 | W/D | 1.09 | 1.30 | 0.4 | Good |
| Example 10 | II | G | 90 | W/D | 1.11 | 1.67 | 0.2 | Good |
| Comparative | II | B | 65 | W/D | 0.77 | 0.92 | 0.6 | Poor |
| Example 1 | | | | | | | | |
| Comparative | II | B | 24 | W/D | 2.08 | 2.71 | −0.4 | Poor |
| Example 2 | | | | | | | | |
| Comparative | II | E | 80 | W/D | 1.25 | 1.88 | −0.1 | Average |
| Example 3 | | | | | | | | |
| Comparative | I | B | 64 | W/D | 0.78 | 0.94 | 0.4 | Poor |
| Example 4 | | | | | | | | |
| Comparative | III | B | 67 | W/D | 0.75 | 0.90 | 0.3 | Poor |
| Example 5 | | | | | | | | |
| Comparative | II | F | 30 | W/D | 0.83 | 1.00 | 0.0 | Poor |
| Example 6 | | | | | | | | |
| Comparative | II | H | 92 | W/D | 1.09 | 1.63 | −0.1 | Average |
| Example 7 | | | | | | | | |
| Comparative | II | D | 95 | W/W | 1.58 | 1.79 | −0.3 | Good |
| Example 8 | | | | | | | | |
| Comparative | II | B | 49 | W/W | 1.02 | 1.22 | −0.5 | Poor |
| Example 9 | | | | | | | | |

As shown in Table 3, in the magnetic recording mediums fabricated by the wet-on-dry process in which the thickness Z of the magnetic layer 3 is 100 nm or less, the average particle diameter Da (nm) of the abrasive particles and the thickness Z (nm) of the magnetic layer satisfy the relationship 1.0≦Da/Z≦1.5, and the maximum particle diameter Dm (nm) and the thickness Z (nm) of the magnetic layer satisfy the relationship Dm/Z≦1.8 in Examples 1 to 10, a good electromagnetic conversion characteristic is exhibited and excellent running durability is achieved.

The reason for this is that because of the film formation by the wet-on-dry process, coating defects due to interface fluctuation between the nonmagnetic underlayer and the magnetic layer do not occur, fluctuation in the thickness of the magnetic layer can be suppressed, and in particular, an extremely thin magnetic layer can be formed. Furthermore, since the number, shape, size of the abrasive particles exposed to the surface of the magnetic layer are appropriately controlled, noise reduction is performed and good running performance is ensured.

On the other hand, in Comparative Examples 1, 4 to 6, in which the Da/Z value is less than 1.0, since the average particle diameter and the maximum particle diameter of the abrasive particles are small relative to the recording wavelength, noise is in the range that does not cause any problem, and the electromagnetic conversion characteristic is in the range that does not cause a problem from a practical standpoint. However, since the number of abrasive particles exposed to the surface of the magnetic layer is extremely small, the effect of removing the accretions generated by excessive wear of the magnetic head is not sufficiently obtained, and in particular, in long-time running, it is not possible to ensure good running durability.

Furthermore, in Comparative Examples 2 and 3, in which the ratio Dm/Z of the maximum particle diameter Dm (nm) to the thickness Z (nm) of the magnetic layer exceeds 1.8, the roughness of the outermost surface of the magnetic layer increases, resulting in uneven abrasion of the GMR reproducing head. Thus, both the electromagnetic conversion characteristic and running durability are evaluated to be not satisfactory from a practical standpoint.

Furthermore, in Comparative Example 7, in which the pH of α-alumina used as the abrasive is higher than 7.0, dispersion is insufficient and surface properties are degraded presumably due to aggregates of α-alumina, resulting in uneven abrasion of the GMR head. Thus, both the electromagnetic conversion characteristic and running durability are evaluated to be not satisfactory from a practical standpoint.

Furthermore, in each of Comparative Examples 8 and 9, in which dual-layer coating of the nonmagnetic underlayer and the magnetic layer is performed by the wet-on-wet process, coating defects and degradation of the surface state of the magnetic layer are caused due to interface fluctuation between the upper and lower layers, and the electromagnetic conversion characteristic is degraded due to an increase in noise.

In particular, in Comparative Example 9, in which the magnetic layer is extremely thin, the degradation of the surface state of the magnetic layer due to interface fluctuation between the upper and lower layers is great, and both the running durability and the electromagnetic conversion characteristic are evaluated to be not satisfactory from a practical standpoint.

It should be understood by those skilled in the art that various modifications, combinations, sub-combinations and alterations may occur depending on design requirements and other factors insofar as they are within the scope of the appended claims or the equivalents thereof.

What is claimed is:

1. A magnetic recording medium comprising:
a nonmagnetic substrate;
a nonmagnetic underlayer containing at least inorganic particles and a binder resin; and
a magnetic layer containing at least a magnetic powder, a binder resin, and abrasive particles, the nonmagnetic underlayer and the magnetic layer being disposed in that order on at least one principal surface of the nonmagnetic substrate,
wherein the magnetic layer is formed after a coating material for forming the nonmagnetic underlayer is applied and subjected to drying treatment;
the thickness Z of the magnetic layer is 100 nm or less;
the average particle diameter Da (nm) of the abrasive particles and the thickness Z (nm) of the magnetic layer satisfy the relationship 1.0≦Da/Z≦1.5; and
the maximum particle diameter Dm (nm) and the thickness Z (nm) of the magnetic layer satisfy the relationship Dm/Z≦1.8.

2. The magnetic recording medium according to claim 1, wherein the abrasive particles are composed of α-alumina having a pH of 7.0 or less.

3. The magnetic recording medium according to claim 1, wherein a magnetoresistive (MR) head or a giant magnetoresistive (GMR) head is used as a magnetic reproducing head.
